(19) United States
(12) Patent Application Publication
(10) Pub. No.: US 2007/0012259 A1
(43) Pub. Date: Jan. 18, 2007

(54) BRIGHT WHITE AND COLORED ABSORBANT PARTICULATE

(76) Inventor: Douglas E. Ellis, Surrey (CA)

Correspondence Address: PERKINS COIE LLP, POST OFFICE BOX 1208, SEATTLE, WA, 98111-1208, US

(21) Appl. No.: 11/457,054

(22) Filed: Jul. 12, 2006

Related U.S. Application Data
(60) Provisional application No. 60/699,002, filed on Jul. 12, 2005.

(51) Int. Cl. A01K 1/015

(52) U.S. Cl. 119/526

(57) ABSTRACT

A cellulose particulate provides a safe and aesthetic bedding or litter material for small animals. The material may be provided in bright white or in vivid colors. Brightness and color clarity are maintained during manufacture by apparatus having non-corroding surfaces. The material offers aesthetic elements in small animal cages or enclosures. The material may be formed into particles having no sharp edges or corners. This provides a safe and comfortable bedding or litter material for small animals.

This Application claims priority to U.S. Provisional Patent Application No. 60/699,002, filed Jul. 12, 2005, and incorporated herein by reference.

Bedding and litter materials used for hamsters, mice, gerbils, rabbits, reptiles, birds and numerous other small animals were traditionally produced from wood shavings, corn cob or shredded recycled paper. In about 1990, these materials were largely replaced with engineered pulp and paper mill waste-based beddings. The engineered pulp and paper bedding provided better odor control and lower levels of the harmful substances found in traditional pine and cedar shavings. These engineered bedding products have performed well. However, they have a brown or grey color which is often considered to be undesirable.

Color measurement of paper and pulp products is expressed on the ISO scale, using a rating where 0 is black and 100 is pure white. The scale is an indication of deviation from the center or “pure balance”. The scale is somewhat based on human ability to distinguish differences and 0.1 is the minimum distinguishable difference. Office paper suppliers often recommend a brightness index of about 97% for higher quality paper, and a brightness index of about 84% for paper used in ordinary printing.

An off white small animal bedding product has been commercially produced using a mix of bleached Kraft pulp fiber and other off grade white pulp. This product, provided as flat and generally square pieces, has a brightness rating of 71%. The flat pieces also are not well adapted for use as animal bedding, as they tend to lay flat on top of each other, have sharp corners and edges, and do not allow for animal burrowing. Other small animal bedding products generally have had varying performance characteristics and are available only in dull white, grey or brown colors. Accordingly, small animal bedding and litter products having good performance and greater color and appearance selection characteristics are needed.

### SUMMARY OF THE INVENTION

A new small animal bedding or litter product has now been invented which can provide superior performance and appearance. In one form, this new product has a natural soft fluffy non-angular texture. It may be provided with an aesthetic bright white appearance. Stainless steel, plastics, fiberglass, or other non-reactive materials, may be used in the manufacturing machinery to reduce or eliminate the loss of brightness, caused e.g., by rust or dirt contamination in conventional machinery. The process tanks and equipment may also be designed for quick and easy cleaning to minimize buildup of contaminants. Use of these manufacturing techniques, and a bright white feed stock, can provide a significantly brighter white small animal bedding. Brightly colored bedding and litter is also provided.

### BRIEF DESCRIPTION OF THE DRAWINGS

FIG. 1 is flow chart of one process for manufacturing the animal bedding or litter product described above.

FIG. 2 is schematic diagram of system for coloring an animal bedding or litter product.

FIG. 3 is a perspective view of the animal bedding or litter product in use in a small animal tank or cage.

### DETAILED DESCRIPTION

A bright white small animal bedding, and/or litter material and a vivid bright colored small animal bedding or litter materials are provided with a paper brightness in excess of about 75, 80, 82, 85, 90%, or even higher. The product may also be non-angular and substantially free of the sharp angular edges typically produced in cutting of pulp and paper materials. As used here, non-angular means having substantially no sharp points and no sharp edges. The product may also be non-flat. As used here, non-flat means that the particles forming the product are not cut or punched from a flat sheet of material. The vivid colored bedding and litter material can be made by coloring a bright base material. Starting with a bright base material allows for a bright vibrant end product. As used here, base material means cellulose, wood pulp, paper pulp, wood shavings, and similar cellulosic materials. The amount of colorant used is limited. This stabilizes the dyes which reduces or avoids color bleeding.

Cellulose containing base materials with a minimum brightness of 40% and preferably above 75% may be used to provide vivid bright colors with minimal colorant levels. The manufacturing equipment advantageously selectively avoids use of materials, such as carbon steel, in critical areas where they can affect the material color (e.g., by rust coloring). Non-reactive or non-corroding materials, such as stainless steel, fiberglass and/or plastics may be used. As used here, substantially non-reactive material means stainless steel and similar corrosion resistant alloys, including non-ferrous alloys, fiberglass and other fiber-based materials, composite and laminated materials, plastic materials, and other materials that do affect the brightness or color of the base material being processed.

Typically, these materials are corrosion resistant or non-corroding materials. Equipment described here as non-reactive or made of a non-reactive material, includes equipment having non-reactive liners or surfaces. Of course, only the surfaces of the equipment that come into contact with the material being processed are made non-reactive. Consequently, non-reactive materials here refers to these surfaces or components, and not necessarily to other surfaces or components which may be conventional materials. The manufacturing system may include some carbon steel components, such as in valves, pumps, clamps, bolts, etc. These types of components having smaller surface areas contacting the material being processed may be acceptable if they do not significantly affect the brightness of the end product. Driers used at the end of the process generally also need not have non-reactive material surfaces.

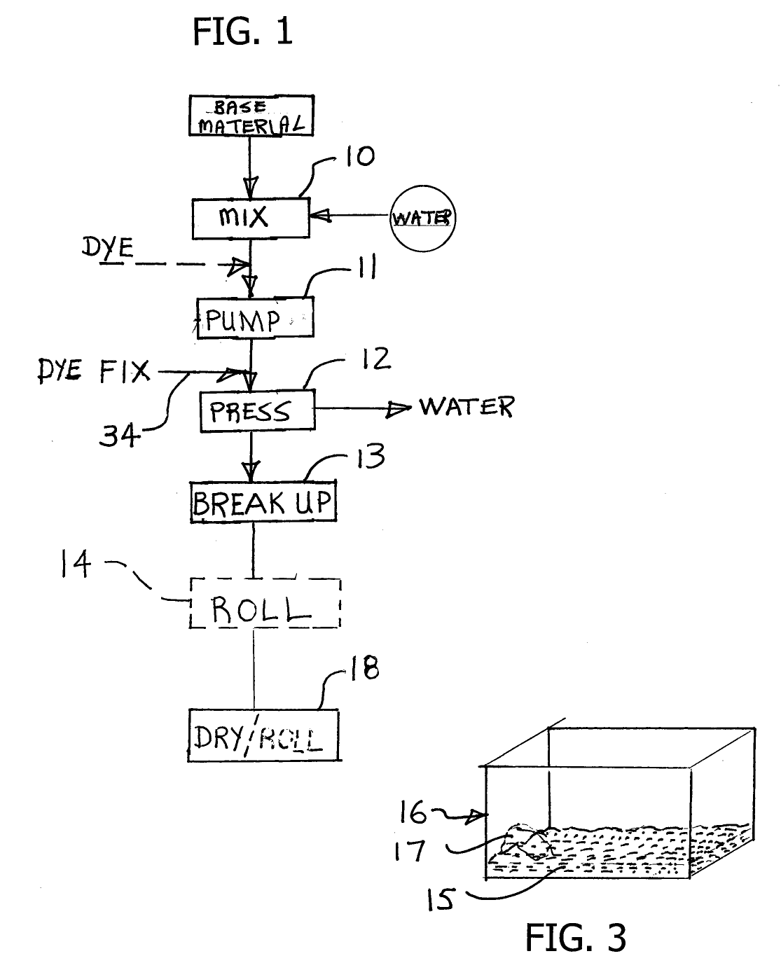

FIG. 1 shows basic steps that may be used to manufacture the product. The product can of course also be made using various other combinations of steps as well. FIG. 1 according is simply an example of one process that may be used. At step 10 in FIG. 1, the base material is mixed with water to form a slurry. The slurry is pumped at step 11 to a press at step 12 where water is removed from the slurry, typically in a press. However, any form of water removing apparatus or step may be used. Dye or other colorant, if used, may be added between the slurrying and pressing steps. However, as described below, colorants may also be added at other times and places in a manufacturing process. At step 13 in FIG. 1, the pressed material is broken up into particles or pieces at step 13, which are then dried at step 18. The particles may have generally random irregular non-flat shapes. They may also come in random sizes, within the upper size limits described below. The particles are also absorbant. They are able to absorb liquid at least 3, 5, 7 or 9 times their weight. The material may be processed as described in U.S. Pat. Nos. 4,931,139; 5,091,245; 5,358,607 or 2004/0216688, each incorporated herein by reference.

The manufacturing equipment is typically capable of de-fibering pulp and paper fibers into individual fibers or fiber small bundles to around a 3% consistency in the presence of water. The pulp slurry may be transferred to a dewatering device such as a twin wire press or a screw press, where the material is dewatered and/or pressed to between 20% and 50% consistency. The dewatered material can then be cut, shredded, chopped, etc. to a particulate size suitable for bedding or litter materials. The resulting particulate is then typically dried to between 86% and 100% dry. This new small animal bedding and litter product may use a bleached white fiber that is processed into near pure cellulose made up of primarily alpha cellulose.

Currently, small animal bedding and litter products are generally dull white, grey or brown. Providing a colored small animal bedding product involves several complicating factors. Coloring agents, such as dye or pigment, when used in this type of product, must of course be non-toxic to both humans and animals. The color in the product must also be colorfast when exposed to water, skin or fur. The color generally should advantageously be substantially uniform, to provide an attractive appearance. Providing a colored small animal bedding or litter product meeting these requirements has remained elusive, to the extent that they have not been previously available in the pet supply industry.

The new product described here can now provide a full array of product colors, and without color bleeding. Brightly colored product can also be made. The product (whether white or colored) may also be made virtually free of lignin, turpines, ray cells, and the organic and inorganic contaminants often found in traditional small animal bedding materials. To make a bright and light colored product, a base material having high brightness, e.g., greater than 75% may be used. For darker colors, less bright base materials may be used, such as a base material having e.g., 40% or 45% brightness. Dye or colorant can be applied to the base material fibers in several ways. Dyeing during the slurrying is easiest to perform, but results in contaminating the whole system with colored material. To minimize contamination and allow for rapid, sharp cutoffs between colors, the dye can be added in close to the stock pump 11, while still allowing sufficient time for thorough mixing and setting. The dye will typically range from about 0.01 to 2.5% dye by weight of dry solids. A flocculant may be added to draw the dye to the fiber material.

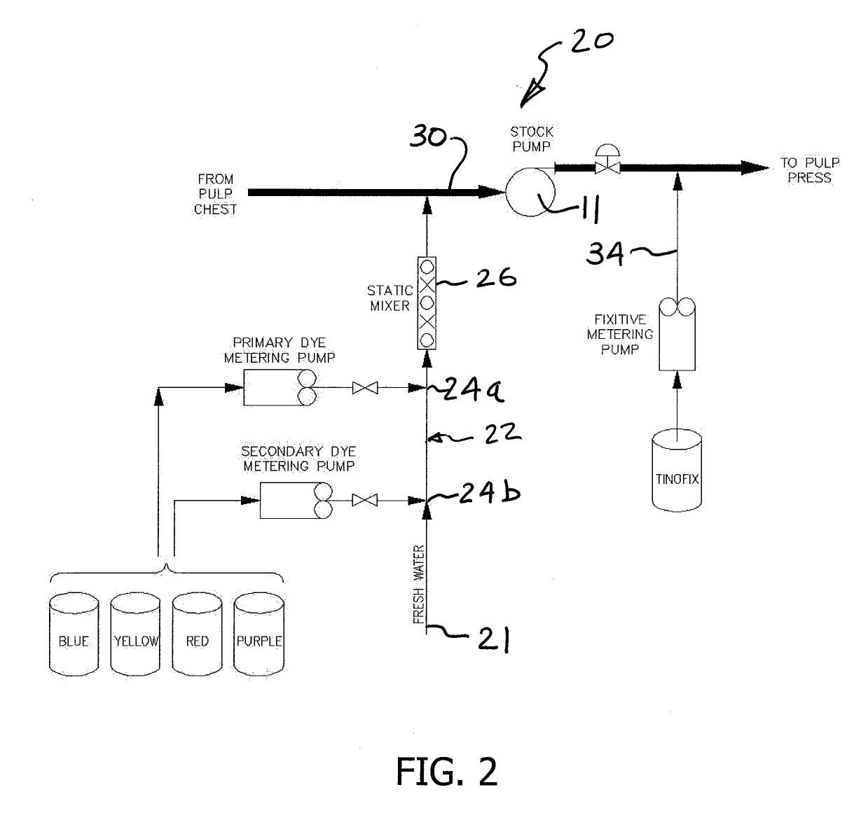

FIG. 2 shows an example of a system for adding color. In FIG. 1, fresh water is provided into the system 20 from a fresh water source 21 to a supply line 22. Primary and secondary dye entry ports 24A and 24B connect liquid dye sources into the supply line 22. A mixer 26 mixes the water and dye(s). The mixed water and dye moves from the mixer 26 and is injected into pulp material moving through a pulp pipe line 30 or similar conveying element, to the stock pump 11. A dye fixative may then added to the pulp in the pulp line from a fixative source 34, at a point where the dye is well disbursed in the pulp. The pulp then moves to a press or other process step.

The order of colors added in the dyeing process may be selected to better optimize the process. For example, the process may start with the lightest color (e.g. yellow) and progress toward darker colors, taking into account the opportunities of transition with mixed dyes (e.g. yellow and blue to make green) in going from one pure color to another. Transitions may be sharpened by cutting off all dye for a period and letting the water system clear. This results in a mixed product during the transitions composed of the first color, white and the second color, which is attractive enough to be sold, thus minimizing waste.

The colorant can be added to the dewatered material after the dewatering press. However, this is generally not preferred if a uniform color is desired. Investigation into spraying the dye onto dry material resulted in a mottled material of the color sprayed and white. It is similar to the transition material described above, except with only one color. The process problem with this approach is the necessity for secondary drying, since the dispersion of the dye requires a dilute solution and results in adding almost 50% by weight water.

Two mechanical aspects of the process may be used to minimize the loss grade changes and clean-up between colors. A twin process water (whitewater) tank system that allows for isolation between colors may be used. The system can have stainless steel or plastic construction to prevent contamination from corrosion or pulp build-up. Stainless or plastic construction may similarly be used after the point of addition to minimize contamination and build-up and also make it efficient to clean up between runs.

The product may be made in a particle form or in a rolled form, among others. Both are highly absorbant with a fast wicking action that quickly moves moisture away without creating wet puddles in the bottom of the small animal cage. In contrast to many other types of bedding materials, the particle form of the product also allows for natural burrowing by small animals, as it is easily burrowed through while holding a cavernous shape. The soft texture of the product is gentle on the face and body of the small animals, as they crawl or walk over and through the product. The particles in the particle form of the product are typically up to about 0.3 inches thick and with a largest dimension of about 1¼ across. Of course, the particles can also be made larger or smaller, depending on various factors. To make the particle form of the product, the material coming out of the press at step 13 in FIG. 1 are shredded into pieces or particles having the sizes described above.

In the rolled form of the product, the material is further processed by rolling and/or compaction at step 14 in FIG. 1, or by rolling and or compaction performed in combination with drying at step 18. Rolling or compaction may be carried out, for example, by using an agglomerating disk, an agglomeration drum or within a rotary dryer. This action serves to further compact the product, increasing its bulk density and producing a rounded product, which may be more suitable as a cat or dog litter. This rounded product may be provided in the form of balls, or of particles having at least rounded surface, formed of interlaced cellulose fibers. More generally, the rounded product is comprised of irregular shaped soft pieces having a largest dimension of up to about one inch. Rounded product with pieces less than or greater than about one inch may of course also be used. The rolled or rounded product typically has a bulk density of from about 6 to 35 pounds/ft³, although densities of from about 7 to 18 pounds/ft³ are generally more often used. In contrast, the particle form of the product typically has a density of about 3-12 pounds/ft³.

The rolled form of the product also typically has an aspect ratio (length to width, or the ratio of the largest two dimensions of the piece) of about 1:1 to about 1:1½ or 2, whereas the particle form of the product typically has an aspect ratio of about 1:2 to about 1:3, or even higher. The particles in the rolled form of the product generally have at least one rounded or spherical surface, although the particles may not be entirely spherical. Smaller particles of the rolled form of the product may have no rounded spherical surfaces, although the majority of the particles, by volume, may have one or more rounded surfaces. The rolled form of the product provides an aesthetically pleasing bright soft non-angular litter useful in helping to monitor animal health through contrasting urine color against the bright white backdrop. This form is especially useful in clinical trials where animal health is closely monitored. When the product is made with near pure alpha cellulose, contamination in research projects from multiple unknown variables is minimized.

FIG. 3 shows an example of the particle form of the product in use. The product 15 is spread out in a layer on the floor of the tank, cage or enclosure 16. The layer is typically about ½ to 3 inches deep. The amount used will vary with different animals. The product may optionally be mixed with conventional bedding or litter products, to add color to these primarily brown or grey products. The product 15 is suitable for burrowing animals, as it can be formed into caverns or hollow mounds 17.

### EXAMPLES

### Example No. 1

Initial attempts to produce a colored litter and bedding were made using pulp mill sludge from Georgia Pacific's Bellingham Washington pulp paper mill. Occasional grade changes and clean outs between colors at the mill's tissue line resulted in colored sludge (waste fiber from the clarifier) being produced. Using a process as disclosed in U.S. Pat. No. 4,931,139, waste pulp material was slurried in a re-pulper to a 3% consistency then dewatered through a belt press, broken up into particles, and dried in a fluid bed dryer. The resulting colored litter materials had an improved appearance in comparison to traditional dark gray/brown litters. The materials of this process were 4 mm to 20 mm particles 3 to 5 mm thick and had a bulk density in the 7 pounds per cubic foot range. The waste colored sludge was inconsistent in availability and quantity, and color tones.

### Example No. 2

Gray/brown sludge was obtained from Georgia Pacific's Bellingham Washington pulp paper mill as a feed stock. The material was slurried in a re-pulper and green dye was added into the re-pulper mixing tank along with a fixative. Using a process as disclosed in U.S. Pat. No. 4,931,139, the material was dewatered through a belt pressing then flaked and dried in a fluid bed dryer. The resulting small animal litter was a dark earthy green color. This process required a large amount of dye and results were not economically viable due to high chemical and processing costs relative to the perceived market value.

### Example No. 3

Deep green, red, and pink colored sludge was obtained from the Crystal papers specialty packaging tissue mill in Middletown, Ohio. Using the process disclosed in U.S. Pat. No. 5,358,607, these samples were rolled into approximately 4 mm balls and dried in a lab. The resulting materials had deep solid colors and a bulk density of 17 pounds/ft³. Inconsistency in supply, no control of the colors, shades or quantity and the potential for excessive dye causing staining and bleeding made this an undesirable product for commercialization.

### Example No. 4

Small animal bedding was produced in a method similar to those disclosed in U.S. Pat. Nos. 4,931,139, and 5,091,245. High alfa cellulose pulp was obtained from Rayonier Specialty Products, Jesup, Ga., USA. (The cellulose may optionally be brightened using one of or a combination of methods such as chlorine, oxygen, ozone, hydrogen peroxide or other brighteners. However, commercially available bleached pulp can be used if available at an economic price.) The pulp was mixed in water and re-pulped in a vertical high consistency stainless steel pulper at a consistency of 4% pulp. The pH was adjusted with 97% sulfuric acid and aluminum sulfate to a pH of 4.8. A latex binding agent was added and the material was transferred with stainless steel and plastic piping to a stainless holding tank. The product was then transferred with stainless steel and plastic piping to a stainless steel twin wire press. Additional water and a flocculent was added in the transfer piping system. The material was dewatered in the press to a 34% solids level and shredded into ¾ inch minus fiber flakes. The flakes or particles were rolled under the presence of spray water mixed with surfactant and an odor controlling metal salt formulation in a stainless inclined screw conveyor. The resulting product was passed through a hot air fluidized bed drying system resulting in a 92% dry final product. The resulting product was tested via ISO 3688/2470 brightness standard to achieve a score of 83% brightness.

### Example No. 5

Small animal bedding was produced in a method similar to those disclosed in U.S. Pat. Nos. 4,931,139, and 5,091,245. A bleached white cellulose pulp similar to that of example #1 was re-pulped into a 2.2% consistency with water then pumped to a twin wire dewatering press. Five different colored dyes were tested by adding the dyes to the slurry before the pump on the way to the dewatering press at rates between 2 pounds per ton and 14 pounds per ton. This produced vivid colored yellow, pink, blue, green and purple pulp sheets that were then processed through shredding and fibril rolling prior to drying in a fluidized hot air dryer. The product physical characteristics were similar to those described in U.S. Pat. Nos. 4,931,139, and 5,091,245. The visual characteristic was a vivid bright evenly colored product with color evenly distributed throughout the particles. The overall colors matched up to a Pantone color matching system colors #127c, 1767c, 637c, 2708u and 186u. Two white mice were placed into a cage with this bedding for two weeks. There was no bleeding of the dyes onto the mice.

### Example No. 6

The process of example #2 was repeated in a small scale lab. Prior to drying, the material was subjected to additional rolling and fiber compaction in a substantially horizontal rotating agglomeration drum. The product was then dried in a rotary dryer producing vivid colored litter products similar in physical character to those described in U.S. Pat. Nos. 5,358,607 and 20040/216688. The resulting product was a vivid bright evenly colored product with color evenly distributed throughout the particles. The overall color matched up to a Pantone color matching system color #1767c.

### Example No. 7

A vivid colored waste pulp sludge was obtained from a tissue mill during a grade change where sufficient amounts of dye were lost in the sludge giving it a blue color. This material was shredded and fed into a substantially horizontal rotating agglomeration drum and then into a rotary dryer to produce colored litter. The resulting product consisted generally of rounded ⅛ to ¼ inch diameter balls with a deep solid blue color.

### Example No. 8

White press cake pulp was obtained after shredding and prior to drying from the process in Example #1. This material was then subjected to a spray of dye while being rolled in a rotating drum. The resulting material was then dried in a lab oven. The material of this process did not get a uniform dye color and was judged to be an inferior product to that produced in Example #6.

### Example No. 9

A clean off white paper 44% solids sludge was obtained from a tissue paper mill. The material when dried had an ISO paper brightness of 72%. The sludge cake was broken into ½ inch minus crumbles and soaked in a 0.75% solution of tap water and PERGASOL violet dye (from CIBA Specialty Products, Suffolk, Va., USA) for thirty seconds. The resulting dyed crumbles were drained and dried in a fluid bed hot air dryer. The resulting product had varied shades of textured color on the surface. The dye did not significantly penetrate the outer 1/16 inch of the material and revealed white spots after nominal handling where small pieces broke off the core the fiber. The overall color matched up to a Pantone color matching system color #2597c.

### Example No. 10

A low inorganic clean pulp mill sludge was obtained and re-pulped similar to example #1. The sludge was a grey brown in color with a tone similar to Kraft paper boxes. A green dye was added to the pulp slurry in a holding tank prior to pumping to a twin wire press. The resulting product was a deep dull green and relatively undesirable for commercial sales. The overall color matched up to a Pantone color matching system color #660u.

### Example No. 11

A bright near-white colored Cotton Wood shaving from a specialty hybrid cotton wood pulp tree was produced and air dried to 86% solids. The resulting shaving had a ISO paper brightness index of 69%. The shavings were soaked in a 0.75% solution of tap water and PERGASOL violet dye for two minutes. The resulting dyed shavings were drained and dried in a fluid bed hot air dryer. The resulting product had a light marbled colored look. The overall color matched up to a Pantone color matching system color #2567c.

Additional testing has proven that the sourcing of clean light colored base materials for litter or bedding products such as bleached white tissue sludge or cotton wood shavings allows for the coloring of these products to form an array of viable colored products suitable for use as litter, bedding products or products for home decor and crafts. Whereas previous attempts to color litter and bedding materials using mill pulp mill sludges, old newsprint paper based pulps and pine and hemlock shavings, took an excessive amount of colorant to produce earthy deep colored products, the new products described above allow for a full range of bright vivid colors including bright whites, pinks, yellows, greens, purples and blues.

The color products described here allow the color concept found in the aquarium gravel market to be applied to small animal bedding and litter substrates. These color products are aesthetically much more attractive in comparison to traditional bedding and litter materials. The products described above are useful as animal bedding and litter. These products may also be used to add color to clear plant vases, color mulch top dressing for flower beds, and as arts and craft and/or decorating materials. The bright white product described above may be useful for traditional small animal beddings and litters where a bright white background is desirable for keeping and displaying cage bound small animals. This product is also useful in tracking animal health as the caged animal's body fluid quantities and colors are easier to monitor.

Various changes can of course be made to the invention in light of the above-detailed description, without departing from the spirit and scope of the invention. In general, in the following claims, the terms used should not be construed to limit the invention to the specific embodiments disclosed in the specification and the claims, but should be construed to include all markers that operated in accordance with the claims. Accordingly, the invention is not limited by the disclosure, but instead its scope is to be determined entirely by the following claims.

1. Animal bedding or litter comprising:
bright white cellulose containing non-flat particles with a brightness greater than 75% on the ISO pulp brightness scale.

2. The animal bedding or litter of claim 1 with the particles capable of absorbing at least 2½ times their weight of liquid.

3. The animal bedding or litter of claim 1 with the particles having a thickness greater than 1 mm.

4. The animal bedding or litter of claim 1 wherein the particles are non-angular.

5. The animal bedding or litter of claim 1 with the particles having an average largest dimension ranging from about ⅛ to 1 inch.

6. The animal bedding or litter of claim 1 with the particles having a density of about 3 to 12 pounds per cubic foot.

7. The animal bedding or litter of claim 1 with at least some of the particles having at least one rounded surface.

8. The animal bedding or litter of claim 7 with the particles having a density of about 6 to 35 pounds per cubic foot.

9. The animal bedding or litter of claim 1 with the particles further comprising an odor-controlling metal salt.

10. The animal bedding or litter of claim 1 wherein the particles have a brightness greater than %80 on the ISO pulp brightness scale.

11. The animal bedding or litter of claim 1 with the particles having substantially random shapes and/or sizes.

12. An animal bedding or litter comprising:
cellulose containing non-flat particles manufactured from a base material having a brightness of at least %45 on the ISO pulp brightness scale and an added coloring agent on and/or in the particles.

13. The animal bedding or litter of claim 12 wherein the particles are non-angular.

14. The animal bedding or litter of claim 12 with the coloring agent comprising a dye making up less than about 1.5% of the dry weight of the animal bedding or litter.

15. The animal bedding or litter of claim 12 with the particles having an average largest dimension ranging from about ⅛ to 1 inch.

16. The animal bedding or litter of claim 12 with the particles having a density of about 3 to 18 pounds per cubic foot.

17. A bright color animal bedding or litter comprising:
cellulose containing non-flat particles manufactured from a base material having a brightness of at least %75 on the ISO pulp brightness scale and an added coloring agent on and/or in the particles.

18. The animal bedding or litter of claim 17 with the particles having a density of about 3-18 pounds per cubic foot.

19. A bright color animal bedding or litter comprising:
cellulose containing non-flat particles manufactured from a base material and with a coloring agent on and/or in the particles, and with the particles having a brightness greater than one or more of Pantone color numbers 3302U, 323U, 2757U, 2765U, 249U, 216U, 229U, 188U, 1817U, 161U, 1265U, 119C, 133C, 140C, 1405C, 1615C, 175C, 188C, 1955C, 222C, 242C, 261C, 2695C, or other equivalent colors.

20. A method of producing a white animal bedding or litter material, comprising:
mixing a high brightness base material with water in equipment where surfaces contacting the base material comprise a non-reactive material, with the base material and the water forming a slurry ranging from about 1% to 8% consistency with water;
removing water from the slurry;
breaking the material into non-angular particles;
drying the particles; and
with the equipment not substantially degrading the brightness of the material resulting in the particles having a brightness greater than 75% on the ISO pulp brightness scale.

21. The method of claim 20 further comprising breaking the material by shredding the material into particles having an average largest dimension ranging from about ⅛ to 1 inch.

22. The of claim 20 further comprising increasing the density of the particles by rolling the particles.

23. A method of producing a colored animal bedding or litter material, comprising:
mixing a base material with water to form a slurry;
dying the base material;
removing water from the slurry;
breaking the material into non-angular particles; and
drying the non-angular pieces.

24. The method of claim 23 with the particles comprising less than 1.5% by dry weight of dye.

25. The method of claim 23 with the particles having an average largest dimension ranging from about ⅛ to 1 inch.

26. The method of claim 23 with the particles having a density of about 3 to 12 pounds per cubic foot.

27. The method of claim 23 with at least some of the particles having at least one rounded surface.

28. The method of claim 27 with the particles having a density of about 6 to 35 pounds per cubic foot.

29. Apparatus for making a bright white animal bedding, comprising:
a base material source;
a mixing vessel positioned to receive base material from the base material source;
a dewatering apparatus;
a first conveying element connecting the mixing vessel to the dewatering apparatus;
a dryer;
a second conveying element connecting the dewatering apparatus to the dryer;
with the surfaces of the mixing vessel, the dewatering apparatus, the first connection, and the second connection that contact the base material made of non-reactive material.

30. The apparatus of claim 29 with the dewatering apparatus comprising a press or a centrifuge.

31. Apparatus for making animal bedding or litter, comprising:
a base material source;
mixing means for mixing base material from the base material source with water, without substantially affecting the brightness of the base material;
water removing means for removing water, without substantially affecting the brightness of the base material;
transport means for moving the mixture of base material and water from the mixing means to the press means, without substantially affecting the brightness of the base material;
a particle maker for forming the pressed material into particles; and
a dryer for drying the particles.

32. An enclosure for holding a small animal, comprising;
a box having a bottom and sides attached to the bottom, with at least one of the sides made of a transparent material; and
an animal bedding material on the bottom, with the animal bedding material comprising non-angular cellulose containing absorbant particles having a density of about 3-35 pounds per cubic foot.

33. The enclosure of claim 32 with the particles having a white color and a brightness greater than 75% on the ISO pulp brightness scale.

34. The enclosure of claim 32 with the particles having a density of about 4-9 pounds per cubic foot.

35. The enclosure of claim 32 with the particles comprising dye.
